(19) United States
(12) Patent Application Publication
(10) Pub. No.: US 2009/0278296 A1
(43) Pub. Date: Nov. 12, 2009

(54) Vise for archery bow

(75) Inventors: Chase Fulcher, Henderson, KY (US); Len Marsh, Pasadena, MD (US)

Correspondence Address: LAW OFFICES OF STUART J. FRIEDMAN, 28930 RIDGE ROAD, MT. AIRY, MD, 21771, US

(73) Assignee: Apple Archery Products, LLC, Manchester, PA (US)

(21) Appl. No.: 12/151,542

(22) Filed: May 7, 2008

(51) Int. Cl. B25B 1/22; B25B 11/00

(52) U.S. Cl. 269/60; 269/71; 269/288

(57) ABSTRACT

A bow vise for clamping an archery bow at three spaced contact points between first and second relatively pivotable bow clamping assemblies movable about a common pivot axis includes a bracket on each assembly spaced from the pivot axis and a pin rotatable in each bracket. One pin has a smooth bore aperture and the other a threaded aperture. A coiled spring biases the assemblies away from each other. A threaded rod passes through both apertures, threads into the threaded aperture and includes a knob at one end for rotatably moving the rod clockwise and counterclockwise. As the rod threads through the threaded aperture, the knob applies a force to one of the brackets to pivot the assemblies toward each other. The bow is configured for rotating the bow about three mutually perpendicular axes and for microadjusting the position of the bow about two such axes.

### FIELD OF THE INVENTION

The present invention relates to a device for holding an archery bow when it is being tuned, adjusted or repaired and, more particularly, to a vise for holding an archery bow which is capable of rotating it about three mutually perpendicular coordinate axes for providing easy access to all portions of the archery bow from a single location without changing position.

### BACKGROUND OF THE INVENTION

Vises for archery bows have been well known for many years and have been used by professional bow repair, adjusting and tuning facilities as well as by avid bow sportsmen who elect to repair, adjust and tune their own bows. One well known bow vise has been commercially available for several years from Apple Archery Products LLC of Manchester, Pa. under the name Infinitely Adjustable Bow Vise which securely and easily clamps an archery bow between protective, plastic coated jaws and allows the bow to be rotated 360° about mutually perpendicular axial and transverse axes. As can be seen in FIG. 1, the prior art bow vise 100 comprises an angle mounting bracket 102 for affixing via bolts or screws to a work bench or other work surface. Mounting bracket 102 supports a swivel vise assembly 104 for 360° rotation about an axially extending axis A extending perpendicularly to the longitudinal extent of the mounting bracket and a transversely extending axis T extending parallel to the longitudinal extent of the mounting bracket. Assembly 104 consists of a first U-shaped assembly 106 including a transversely extending web 108 and two spaced axially extending legs 110,112 defining the U and a base rod 114 extending parallel and opposite to legs 110, 112 from web 108. A second U-shaped assembly 116 comprises a transversely extending web 118 and two spaced axially extending legs 120, 122 defining the U. Assembly 104 is formed of steel rod as is assembly 116, except that leg 120 is formed of tubular steel having an inner diameter slightly greater than the diameter of leg rod 110. Tubular leg 120 slides over leg 110 to create a pivot axis 121 so that the two assemblies can relatively pivot about the pivot axis 121 while defining an angle between their respective web rods 108, 118 which can vary between almost zero degrees and something less than about 45°. As the assemblies are relatively pivoted and the angle between the respective web rods approaches zero degrees, leg 122 of assembly 116 approaches leg 112 of assembly 104 such that an archery bow B spanning the distance between tubular leg 120 and leg 112 will be clamped by leg 122 as it approaches leg 112. Each of the assemblies 104, 116 includes an apertured ring on its end remote from the pivot axis and adjacent the web rods 108, 118. The apertured ring 124 on assembly 104 has a small diameter, slightly less than the diameter of threaded shank 126 to act as a stop for shank 126. The apertured ring 128 on assembly 116 is desirably elongate and has its smallest diameter larger than the diameter of shank 126 such that shank 126 can pass through ring 128 but not through ring 124. The angle between web rods 108, 118 is controlled by threaded shank 126 in conjunction with knob 130 having a threaded recess for receiving threaded shank 126 therein. A spring 132 surrounds shank 126 and has one end seated on apertured ring 124 and its other end seated on a washer surrounding shank 126 just below apertured ring 128 for normally biasing apertured rings 124, 128 away from each other. As knob 130 is rotated clockwise, it threads itself downwardly along threaded shank 126 and, via a washer surrounding shank 126 between apertured ring 128 and knob 130, applies downward pressure to apertured ring 128, causing web rod 118 to pivot about the pivot axis 121 and move downwardly toward web rod 108. The downward movement of web rod 118 moves leg 122 downwardly toward leg 112 to clamp an archery bow positioned on tubular leg 120 and leg 112 in two point contact, i.e., the bow vise contacts the bow at tubular leg 120 and clamps it between legs 112 and 122, as can be seen most clearly in FIG. 1A. To allow the swivel vise assembly 104 to rotate 360° about an axially extending axis, base rod 114 is received within an axially extending sleeve 134 which includes a transversely projecting rod 136 extending parallel to the longitudinal extent of mounting bracket 102. To allow the swivel vise assembly 104 to rotate 360° about a transversely extending axis, projecting rod 136 is received within a transversely extending sleeve 138 which also extends parallel to the longitudinal extent of mounting bracket 102. The rotation of base rod 114 within sleeve 134 and projecting rod 136 within sleeve 138 is controlled by handle controlled set screws 140 extending through apertures in the respective sleeves.

While the aforementioned bow vise known to the prior art is extremely functional and useful for its intended purpose, particularly considering its relatively low cost, it has some shortcomings and lacks some capability which is desirable in bow vises. For example, under some circumstances bows clamped in the prior art bow vise are not as stable as might be desired and, to improve this, the bow clamping function could be improved. In addition, since the apertured rings move in an arc as the web rods are relatively pivoted about the pivot axis, the pivoting motion can occasionally stick as the threaded shank moves through the fixed, elongate aperture ring. Furthermore, controlling bow rotation about the various axes with set screws does not provide sufficiently precise adjustment control for tuning a bow, such as when leveling a bow sight. Moreover, it would be desirable for one working on an archery bow held in a bow vise to be able to remain in a stationary location, where there is immediate access to tools, and not have to move around the bow in order to work on both the front and back sides of a bow. To this end, it would be desirable for a bow vise to allow the archery bow to rotate 360° about a vertical axis in addition to its ability to rotate about axial and transverse axes

Accordingly, there is a need for a bow vise which is durable, easy to use and which can safely, simply and effectively clamp all archery bows, including short limb parallel limb bows, which require clamping only along its limbs, and which has a microadjust capability for tuning the bow as well as the ability to rotate the archery bow 360° about axial, transverse and vertical axes to allow one working on the bow easy access to all portions of the archery bow from a single location without changing position.

### SUMMARY OF THE INVENTION

It is, therefore, a primary object of the present invention to provide a bow vise which is capable of clamping an archery bow and rotating it 360° about axial, transverse and vertical axes.

It is another object of the present invention to provide a bow vise which exhibits improved three point clamping stability compared to the two point clamping of the prior art.

It is still another object of the present invention to provide a bow vise which exhibits an improved, smooth pivoting motion during clamping.

It is yet another object of the present invention to provide a bow vise including improved means for causing the clamping legs of the vise to be moved toward each other.

It is still another object of the present invention to provide a bow vise which has micro rotational adjustment capability about two mutually perpendicular axes.

The foregoing and other objects are achieved in accordance with the present invention by providing a bow vise for clamping an archery bow between first and second bow clamping means, comprising

first and second relatively pivotable bow clamping means movable about a common pivot axis between an open position and a bow clamping position and means for causing said bow clamping means to pivot about said pivot axis relative to each other

said means for causing pivoting comprising first and second rod supporting means on each of said first and second clamping means spaced from said pivot axis, each said rod supporting means including an aperture therethrough and being rotatable about an axis which is generally parallel to said pivot axis, one of said apertures being threaded and the other having a smooth bore, a threaded rod passing through both of said apertures and threadably engaged in said threaded aperture, biasing means extending between said first and second clamping means for biasing said first and second clamping means away from each other and knob means positioned on the end of said threaded rod remote from said threaded aperture for moving said threaded rod in clockwise and counter-clockwise directions,

whereby operating said knob means in one direction causes said threaded rod to thread through said threaded aperture, said knob means applying force to one of said rod supporting means against the biasing force of said biasing means to cause said first and second clamping means to move toward each other into said bow clamping position and operating said knob means in the opposite direction causes said first and second clamping means to move away from each other into said open position.

In another aspect of the present invention, there is provided in a bow vise for securely clamping an archery bow comprising first and second relatively pivotable bow clamping means movable about a common pivot axis between an open position and a bow clamping position and means for pivoting said clamping means relative to each other about said pivot axis, said first clamping means comprising a generally U-shaped bracket having two generally parallel legs and said second clamping means comprising a tubular leg surrounding one of said parallel legs of said U-shaped bracket for defining with said one parallel leg said pivot axis, the improvement comprising said second clamping means comprising a generally F-shaped bracket having a base leg and parallel upper and lower legs, the upper leg of said F-shaped bracket being said tubular leg and the lower leg of said F-shaped bracket extending parallel to the legs of said U-shaped first clamping means and being positioned intermediate the legs of said U-shaped first clamping means when said bow vise is in the clamping position for providing three point clamping contact on said archery bow.

In still another aspect of the present invention, there is provided in a bow vise for securely clamping an archery bow comprising bow clamping means movable between an open position and a clamping position and means for rotating said archery bow about at least one axis, said means for rotating including first elongate means extending in a first direction from said clamping means and first elongate sleeve means receiving said first elongate means through one end thereof, said first elongate means extending through said first sleeve to the opposite end portion thereof, for rotation therewithin, said first elongate means having a first longitudinally extending axis, and rotation control means in releasable engagement with said first elongate means for allowing said first elongate means to be rotated clockwise or counter-clockwise about its axis or to be fixedly held in place against rotation, said clockwise and/or counter-clockwise movement of said first elongate means causing said clamping means to correspondingly rotate in a plane perpendicular to said first longitudinal axis,

the improvement comprising microadjustable means for allowing micro-rotational adjustments of the position of said archery bow, said microadjustable means comprising:

a microadjustment sleeve concentrically mounted over the other end of said first sleeve means;

said microadjustment sleeve engaging said first elongate means when said rotation control means fixedly holds said first elongate means in place against rotation;

first elongate base means attached to the outer surface of said microadjustment sleeve and oriented generally perpendicular to its axis, said base means having end portions extending beyond each side of said microadjustment sleeve;

means for applying an adjustable, controlled force to one of said end portions in a direction generally perpendicular to the longitudinal extent of said elongate base means and to the axis of said microadjustment sleeve;

whereby, with said rotation control means fixedly holding said first elongate means in place against rotation, said force causes said microadjustment sleeve to rotate, thereby causing the engaged first elongate means to likewise rotate which, in turn causes said clamping means to correspondingly rotate in a plane perpendicular to said axis.

In yet another aspect of the present invention, there is provided a bow vise which further includes second elongate base means supported opposite said first elongate base means on the other side of said microadjustment sleeve and out of contact with said microadjustment sleeve, said second elongate base means having end portions extending beyond each side of the microadjustment sleeve and being oriented parallel to and in registry with said first elongate base means, said second elongate base means including a threaded aperture in each of its end portions, threaded rod means extending through said threaded apertures into contact with the corresponding end portions of said first elongate base member, whereby each of said threaded rods can exert an adjustable, controlled force to one of the end portions of said first elongate base member as it is threaded through said threaded apertures.

In still another aspect of the present invention, including means for rotating said archery bow about two mutually perpendicular axes, said means further including second elongate means extending in a direction perpendicular to said first direction and second elongate sleeve means receiving said first elongate means through one end thereof, said second elongate means extending through said second sleeve to the opposite end portion thereof, for rotation therewithin, said second elongate means having a second longitudinally extending axis, and rotation control means in releasable engagement with said second elongate means for allowing said second elongate means to be rotated clockwise or counter-clockwise about its axis or to be fixedly held in place against rotation, said clockwise and/or counter-clockwise movement of said second elongate means causing said clamping means to correspondingly rotate in a plane perpendicular to said second longitudinal axis, and second microadjustable means mounted on said second sleeve, the microadjustment sleeve of said second microadjustable means being attached to said second elongate means when said rotation control means fixedly holds said second elongate means in place against rotation.

### BRIEF DESCRIPTION OF THE DRAWINGS

FIG. 1 is a perspective view of a prior art bow vise.

FIG. 1A is a perspective view of an archery bow clamped via two point contact in a prior art bow vise.

FIG. 2 is a schematic view showing the three coordinate axes about which the bow vise of the present invention is capable of rotating a bow clamped therein.

FIG. 3 is a perspective view of the bow vise of the present invention.

FIG. 4 is an exploded perspective view of the bow vise FIG. 2 viewed from the bottom.

FIG. 5 is a perspective view of the swivel vise subassembly of the bow vise of FIG. 2.

FIG. 6 is a perspective view of the U-shaped assembly of the swivel vise subassembly.

FIG. 7 is a perspective view of the F-shaped assembly of the swivel vise subassembly.

FIG. 8 is a perspective view of a retaining pin having a threaded bore for use in the swivel vise subassembly.

FIG. 9 is a perspective view of a retaining pin having a smooth bore for use in the swivel vise subassembly.

FIG. 10 is a perspective of an archery bow clamped via three point contact in a prior art bow vise.

FIG. 11 is a front perspective view of the bow vise of the present invention having an archery bow clamped in the swivel vise subassembly, showing in phantom the bow rotated about 45° clockwise and counter-clockwise about the axially extending axis of the bow vise.

FIG. 12 is a side perspective view of the bow vise of the present invention having an archery bow clamped in the swivel vise subassembly, showing in phantom the bow rotated about 90° clockwise and counter-clockwise about the transversely extending axis of the bow vise.

FIG. 13 is a front perspective view of the bow vise of the present invention having an archery bow clamped in the swivel vise subassembly, showing in phantom the bow rotated about 90° clockwise and counter-clockwise about the vertically extending axis of the bow vise.

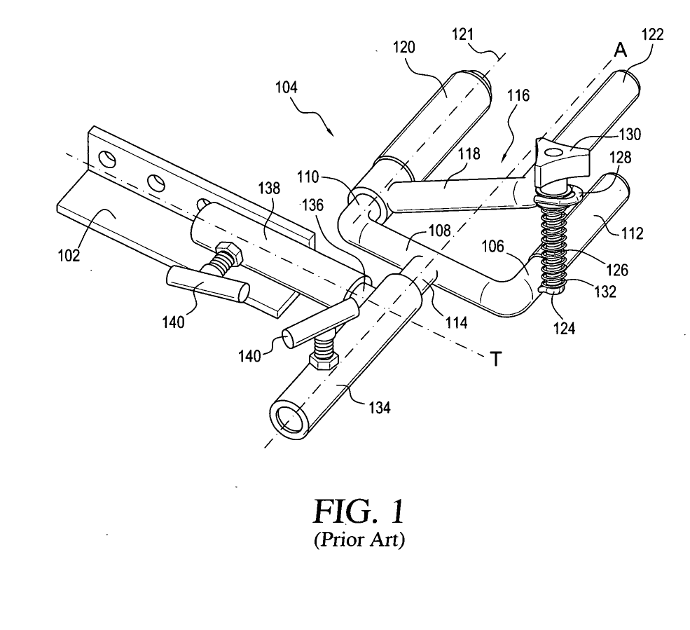

### DESCRIPTION OF THE PREFERRED EMBODIMENT

Over the past few years, the parallel limb bow has become the bow of choice in the compound bow market and variations on the general concept of the parallel limb bow are manufactured by virtually every bow manufacturer. Compared to standard bows with upright limbs, parallel limb bows have very little recoil and less noise. Therefore there has developed a large demand for the parallel limb style of bow and manufacturers offer these bows in varying degrees of parallel. Basically, a parallel limb bow is a bow that has a long riser and short swept back limbs which are oriented more or less horizontally at full draw. The limbs of a parallel limb bow angle back directly towards the shooter as the bow is drawn. More recently, the trend has been toward shorter limb length parallel limb bows having split limb ends to accommodate the cams and cabling used in modern bows. This has created additional problems for tuning, repair and adjustment of the bows. Due to the configuration of the risers and limbs of these bows, holding them securely in a bow press requires clamping them at one end along the limbs. Even the most cutting edge bow vises, using conventional two point contact clamping, have difficulty in maintaining the stability of these modern bows during repair, adjustment and tuning.

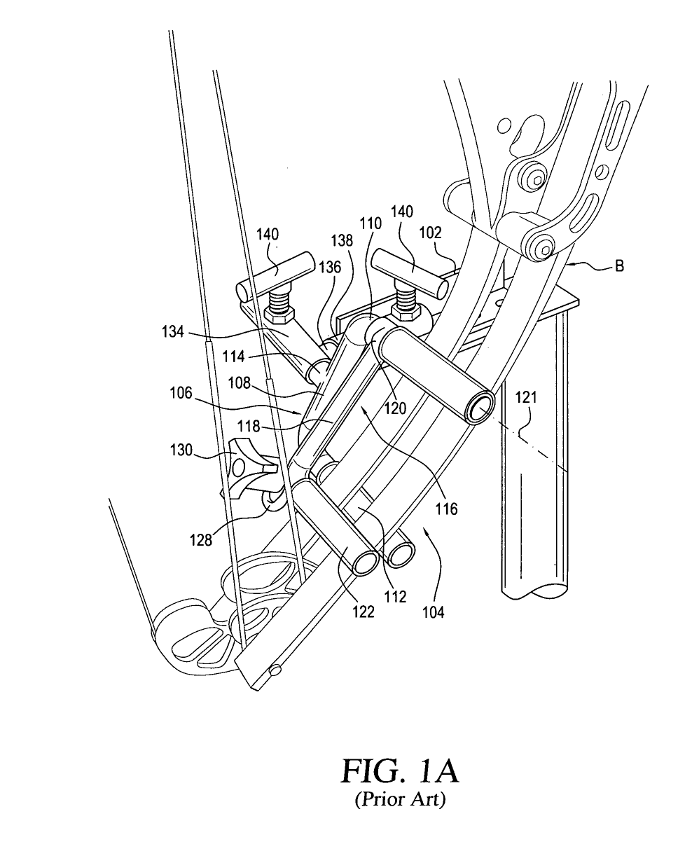

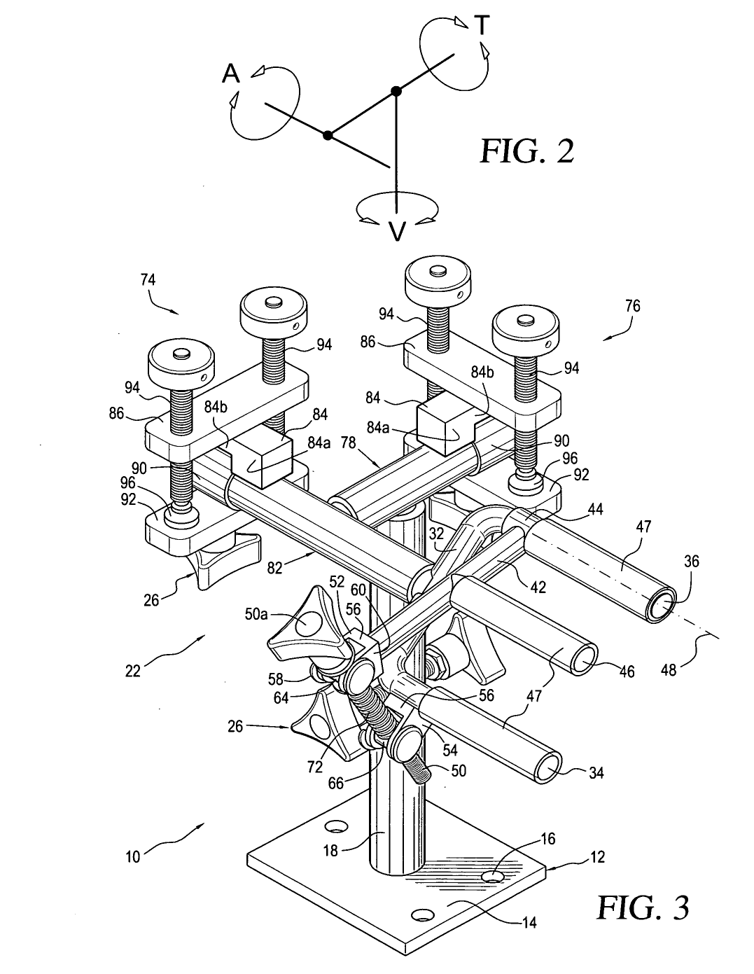

According to the present invention, there is provided a bow vise which is suitable for use with all types of archery bows including parallel limb bows. The bow vise 10 of the present invention is capable of clamping an archery bow and rotating it about three mutually perpendicular coordinate axes for providing easy access to all portions of the archery bow from a single location without changing position. FIG. 2 schematically illustrates the three coordinate axes about which the bow vise of the present invention is capable of rotating a bow. For convenience of description, these three coordinate axes are referred to herein as the axially extending or axial axis, transversely extending or transverse axis and vertically extending or vertical axis. Although the specific direction of each axis can change depending upon the selected orientation of the archery bow, the mutually perpendicular relationship between the three axes does not change. This being understood, the present invention is described herein in terms of the directions illustrated in the accompanying drawings.

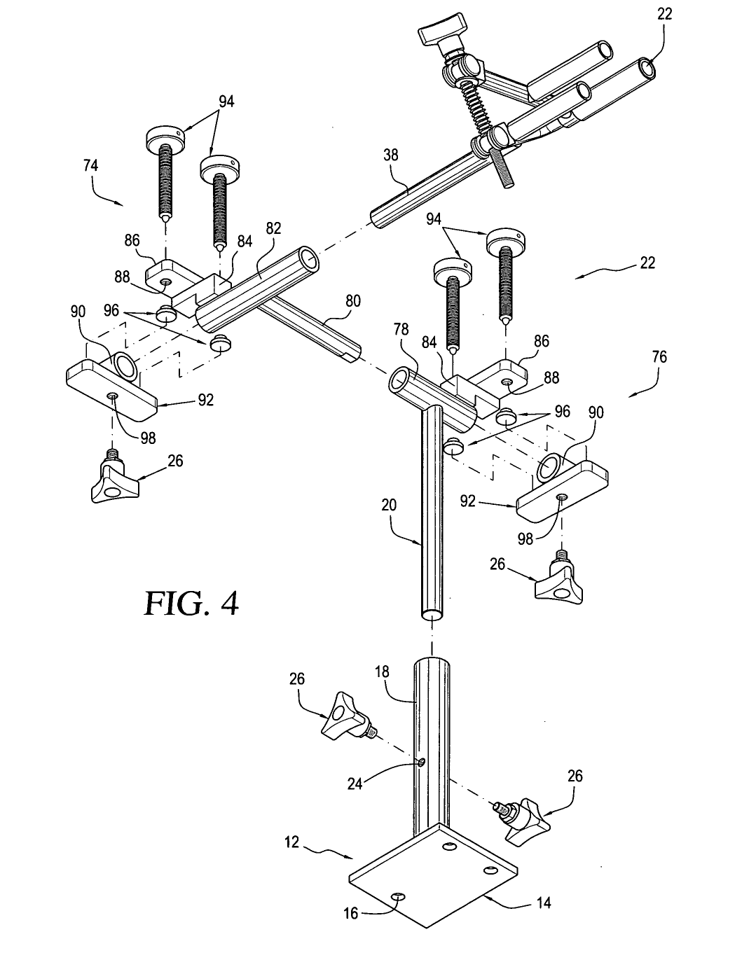

Referring to FIGS. 3-4, bow vise 10 comprises a pedestal base 12 including a flat plate base 14, preferably formed of steel, having a plurality of spaced apart apertures 16 to receive bolts or screws to rigidly mount the bow vise to a work table or other work surface. It will be appreciated that other forms of mounting well known in the art could be used and the base 14 can be configured appropriately for each type of mounting. A hollow tube 18 extends upwardly from the base 14 for receiving a pedestal mounting rod 20 which is affixed to the microadjustable swivel vise assembly 22 of the present invention. Pedestal mounting rod 20 desirably has one or more flats formed along its length and hollow tube 18 has one or more circumferentially spaced apart and/or longitudinally spaced apart threaded apertures 24 formed therein for receiving the threaded shanks of threaded knobs 26 (hereinafter “threaded knobs 26”). When the threaded knobs 26 are tightened within threaded apertures 24 into contact with the flats of the pedestal mounting rod 20, the pedestal mounting rod is securely held in place and the microadjustable swivel vise assembly 22 is fixedly held in place thereon and cannot rotate about the vertical axis V of the hollow tube 18. However, when threaded knobs 26 are loosened, the microadjustable swivel vise assembly 22 and attached pedestal mounting rod 20 may be rotated 360° about the vertical axis of hollow tube 18. This is an important aspect of the present invention since it allows one to work on both the front and back of an archery bow clamped in the vise assembly 22 from a stationary location. Operations such as installing a sight and installing an arrow rest are examples of operations which would be particularly benefited from this 360° rotational flexibility about a vertical axis.

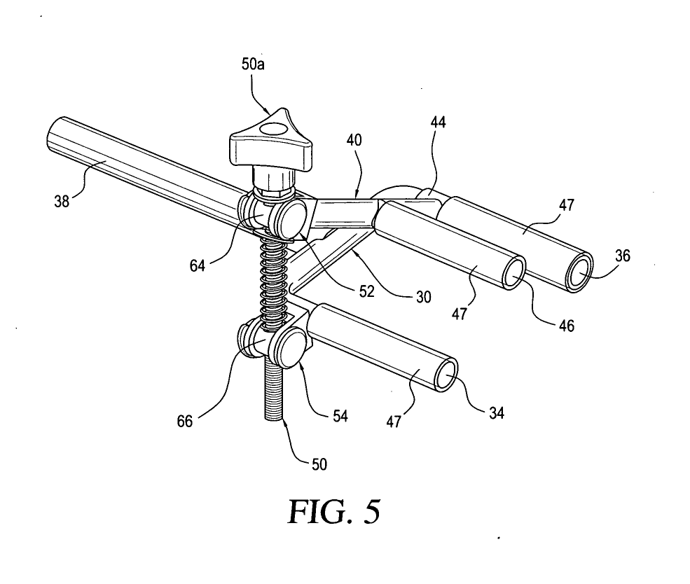

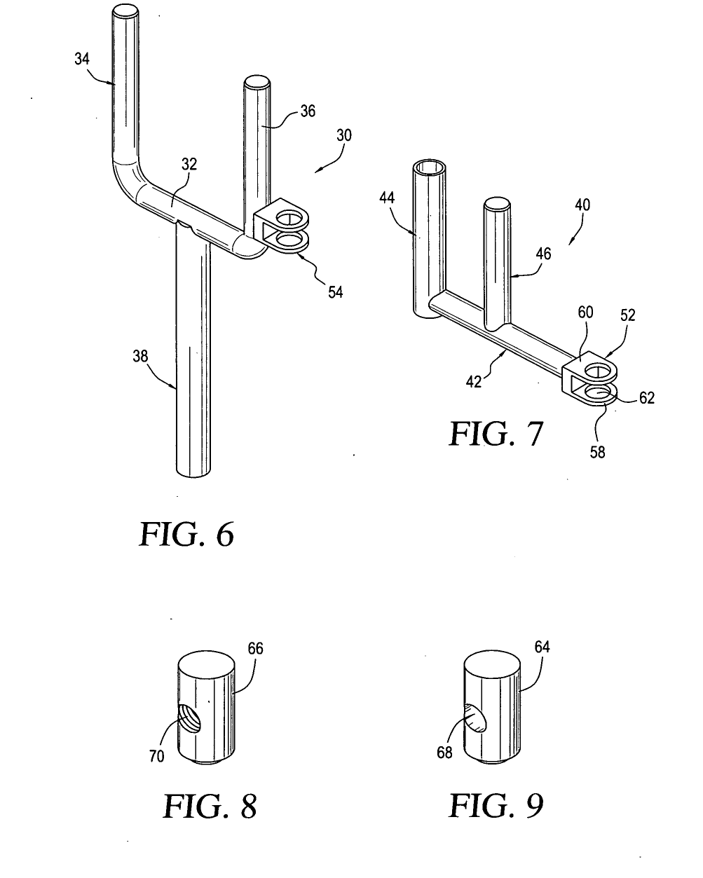

As can be seen from FIGS. 3-10, microadjustable swivel vise assembly 22 consists of a U-shaped assembly 30 including a transversely extending elongate web 32 and two spaced axially extending legs 34, 36 defining a planar U-shape and a base rod 38 extending parallel and in a direction opposite to legs 34, 36 from web 32. Vise assembly 22 also consists of an F-shaped assembly 40 including a transversely extending elongate web 42 and two spaced axially extending legs 44, 46, one leg 44 at one end of web 42 and the other leg 46 positioned intermediate the ends of web 42, preferably at about its midpoint, defining a planar F-shape. U-shaped assembly 30 is formed of steel rod as is F-shaped assembly 40, except that leg 44 is formed of tubular steel having an inner diameter slightly greater than the diameter of leg 34. Tubular leg 44 slides over leg 34 to create a pivot axis 48 so that the U-shaped and F-shaped assemblies can relatively pivot about the pivot axis 48 while defining a variable angle between their respective web rods 32, 42 which can vary between almost zero degrees and something less than about 45°. As the assemblies are relatively pivoted and the angle between the respective web rods 32, 42 approaches zero degrees, leg 46 of F-shaped assembly 40 approaches a position where it is almost coplanar with tubular leg 44 and leg 36, but positioned between those legs, preferably about at their midpoint. Thus, an archery bow having its riser or limbs spanning the space between and in contact with tubular leg 44 and leg 36 will be clamped by leg 46 at a position between leg 44 and leg 36 causing the archery bow to be securely held by the clamping action in three spaced point contact. Each of legs 36, 44 and 46 are covered by a plastic sheath 47 or coated in plastic, such as vinyl, to provide a padded and friction enhancing material between the bow and the contact fingers to protect the finish on the bow. It has been found that a bow clamped at three spaced points is more stable and securely held than a bow clamped at only two spaced points.

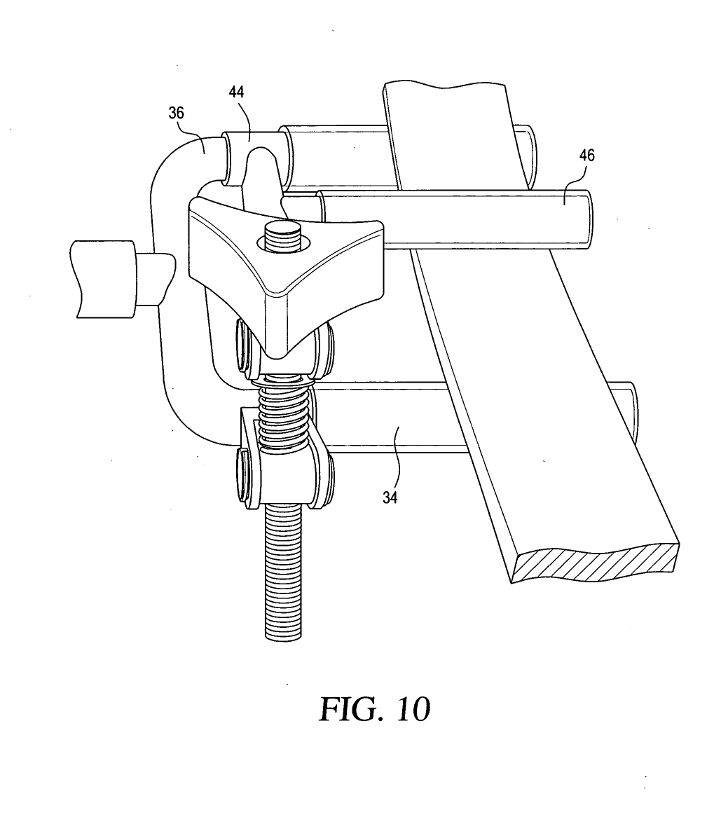

The angle formed between the pivoted U-shaped assembly 30 and F-shaped assembly 40 is controlled by a knob-operated threaded shank 50 which extends between and through clevis brackets 52, 54 extending in a transverse direction from the free end of the web rod 42 of the F-shaped assembly and in a transverse direction from the side of leg 34 remote from the pivot axis 48, desirably at a point along leg 34 a short distance toward its free end from the web rod 32. Each of the clevis brackets 52, 54 is generally U-shaped, including a flat base 56 affixed to the respective assemblies 30, 40 and opposed, generally parallel upstanding ears 58, 60 extending transversely outwardly from the respective assemblies 30, 40. Ears 58, 60 include apertures 62 therein for receiving a relatively large diameter, generally cylindrical pin 64, 66 therethrough which is rotatable about its axis within apertures 62. The axis of pins 64 is arranged generally parallel to pivot axis 48. Pin 64 in bracket 52 has a smooth bore 68 therethrough and pin 66 in bracket 54 has a threaded bore 70 therethrough, bore 68 being of a diameter sufficient for threaded shank 50 to pass therethrough and bore 70 being of a diameter to threadably receive threaded shank 50 therein. Pins 64, 66 in one embodiment, are maintained within brackets 52, 54 by threaded shank 50 passing therethrough. In another embodiment, the pins 64, 66 may have an enlarged head at one end and a circumferential groove adjacent the other end for receiving a holding clip. Threaded shank 50 has a knob 50a, which may instead be a lever, handle, etc. (hereinafter “knob means”), affixed to one end. The other end is inserted through bore 68 and threaded through bore 70. A coiled spring 72 surrounds threaded shank 50 and has one end seated on pin 66 and its other end seated on pin 64 for normally biasing brackets 52, 54 away from each other. As knob 50a is rotated clockwise, it causes threaded shank to move downwardly through threaded bore 70 and, via a washer surrounding threaded shank 50 between bracket 52 and knob 50a, applies downward pressure to bracket 52, causing web rod 42 to pivot about the pivot axis 48 and move downwardly toward web rod 32. The downward movement of web rod 42 moves leg 46 downwardly toward a position between and almost coplanar with leg 34 and tubular leg 44 to clamp an archery bow positioned between and resting on tubular leg 44 and leg 34 in three point contact, i.e., the bow vise contacts the bow at tubular leg 44, leg 46 and leg 34, as can be seen most clearly in FIG. 10. Using the aforedescribed construction, no sticking of the threaded shank is experienced as knob 50a is rotated to move leg 46 into clamping position with tubular leg 44 and leg 34. This is because pins 64, 66 can continuously rotate within apertures 62 as needed to maintain a straight line relationship between bores 68, 70, allowing threaded shank 50 to move smoothly through bores 68, 70 notwithstanding that the brackets 52, 54 trace an arc as the bow vise opens and closes.

An important aspect of the bow vise 10 is its ability to be rotated about three mutually perpendicular coordinate axes for providing easy access to all portions of the archery bow to a user from a single location without changing position. The ability of the bow to rotate 360° about the vertical axis of hollow tube 18 has already been discussed hereinbefore. This is an important aspect of the present invention since it allows one to work on both the front and back of an archery bow clamped in the vise assembly 22 from a stationary location. Another important aspect is that the archery bow clamped in the vise assembly 22 can be rotated 360° about both the axial and transverse axes as well as about the vertical axis. As previously stated, the ability to rotate a bow about the axial and transverse axes is well known. However, prior art bow vises were only capable of macro adjustments made by loosening the handle controlled screws locking the bow in place, hand rotating the bow to a desired position and then retightening the handle controlled locking screws. With only this adjustment capability, it could take a considerable amount of time and much patience to position a bow precisely as desired, e.g., when leveling a bow sight. In accordance with the present invention, rotation of the bow around the axial and transverse axes may be microadjusted by using microadjustment assemblies 74, 76 positioned, respectively, on the axial and transverse axes. The following discussion will aid in understanding the operation of bow vise 10 in terms of its ability to microadjustably control the 360° rotation and positioning of archery bows clamped in vise assembly 22.

Mounted atop pedestal mounting rod 20 is a transversely aligned sleeve 78 which receives a transversely extending rod 80 extending perpendicularly from an axially aligned sleeve 82. To allow the swivel vise assembly 22 to rotate 360° about an axially extending axis, base rod 38 of U-shaped assembly 30 is received within and extends through the axially extending sleeve 82. Swivel vise assembly 22 is able to rotate 360° about a transversely extending axis by virtue of transversely extending rod 80 projecting into and through transversely extending sleeve 78. The rotation of base rod 38 within sleeve 82 to rotate an archery bow about axial axis A and transverse rod 80 within sleeve 78 to rotate an archery bow about transverse axis T is controlled by threaded knobs 26 extending through threaded apertures in microadjustment assemblies 74, 76 into contact with rods 80, 38, respectively, as will be more fully detailed hereinafter. When threaded knob 26 is tightened within a threaded aperture in microadjustment assembly 74 into contact with base rod 38, the base rod is securely held in place and the swivel vise assembly 22 is fixedly held in place and cannot rotate about the axial axis A. Likewise, when threaded knob 26 is tightened within a threaded aperture in microadjustment assembly 76 into contact with transverse rod 80, the transverse rod is securely held in place and the swivel vise assembly 22 is fixedly held in place and cannot rotate about the transverse axis T. However, when threaded knobs 26 are loosened, the swivel vise assembly 22 may be freely rotated 360° by hand about the vertical axis of hollow tube 18, the axial axis of sleeve 82 and the transverse axis of sleeve 78 to reposition the archery bow clamped in vise assembly 22. However, as previously indicated this hand repositioning only allows macro movements of the archery bow and makes it difficult to precisely position the archery bow, as for leveling a bow sight.

In accordance with the present invention, microadjustment assemblies 74, 76 are positioned on axial sleeve 82 and transverse sleeve 78, respectively, to allow fine adjustment of the rotational positioning of an archery bow about the axial and transverse axes. Each microadjustment assembly 74, 76 is the same and includes an L-shaped spacer block 84 having one leg 84a affixed to the upper surface of axial/transverse sleeve 82, 78 at a point spaced from the rear end of the sleeve with the projecting leg 84b of the L-shape extending rearwardly An upper microadjust base 86 is attached to the upper surface of spacer block 84, extending beyond each side of spacer block 84, and includes a pair of spaced threaded apertures 88 positioned on opposite sides of spacer block 84. A microadjust sleeve 90 slides over the rear end of sleeve 82, 78 until its forward end abuts leg 84a. Sleeve 90 includes a lower microadjust base 92 affixed to the lower surface thereof and positioned such that lower microadjust base 92 underlies and is in registry with upper microadjust base 86. A pair of threaded thumb screws 94 extend downwardly through threaded apertures 88 in the end portions of upper microadjust base 86 into contact with swivel pads 96 on the upper surface of end portions of lower microadjust base 92. A threaded aperture 98 extends through lower microadjust base 92 and microadjust sleeve 90 for receipt of threaded knobs 26 which may be tightened or loosened to make macro adjustments of the position of an archery bow about the axial and transverse axes, as hereinbefore described. It is desirable that axial/transverse sleeves 82, 78, spacer block 84 and upper microadjust base 86 are formed as a unitary element, as by welding. Likewise, it is desirable that microadjust sleeve 90 and lower microadjust base 92 are formed as a unitary element, as by welding.

In order to microadjust the rotational position of an archery bow clamped in swivel vise assembly 22, it is desirable to first macro adjust the rotational position relative to the axial and/or transverse axes to closely approximate the desired position and then lock in this macro position by tightening threaded knobs 26. With threaded knobs 26 tightened, no further macro adjustment by hand is possible. At this time, the appropriate microadjustment assembly 74, 76 is used to micro adjust to reach the final desired rotational position of the archery bow. This is achieved by operating the thumbscrews 94 in their respective swivel pads 96 to tighten the thumb screw on the side corresponding to the rotational direction in which bow movement is desired and to loosen the other thumb screw. This has the effect of applying a downward force on one side of lower microadjust base 92 which causes attached microadjust sleeve 90 to rotate clockwise or counter-clockwise, depending upon the direction of the applied force. Inasmuch as microadjust sleeve 90 is fixedly attached to either base rod 38 or transverse rod 80 (depending upon which microadjustment assembly is being operated) through threaded knobs 26, the rod 38, 80 also rotates causing the archery bow to correspondingly rotate about the respective axial or transverse axis. It will be appreciated that using the thumbscrews 94 to rotate the archery bow allows very fine micro rotational adjustment of the archery bow position. This is particularly important for allowing a user to level a bow on both the axial and transverse axes, for example when tuning a bow by leveling a bow sight. The micro adjustments permit the user to lock-in exact positions and then remove the bow for testing. If the testing reveals that further adjustments are desirable, the bow can be replaced into the bow vise 10 in its previous locked-in position and further adjustments made from there. The microadjustment capability is also important to permit the bow to be precisely horizontally positioned, e.g., for serving string for the nock position when inserting silencers or peeps.

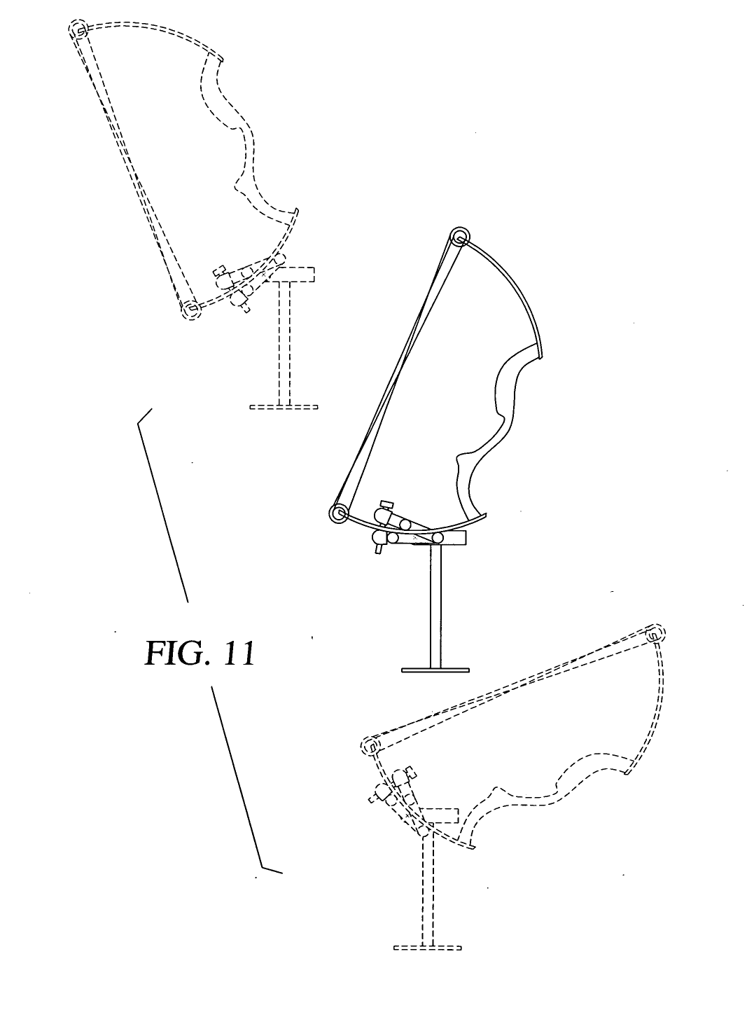

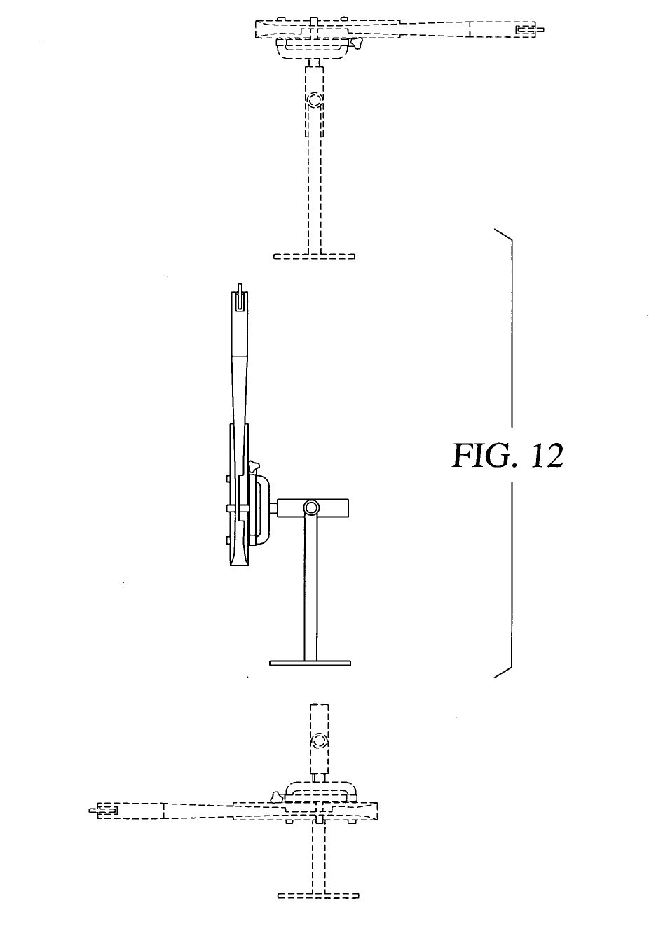

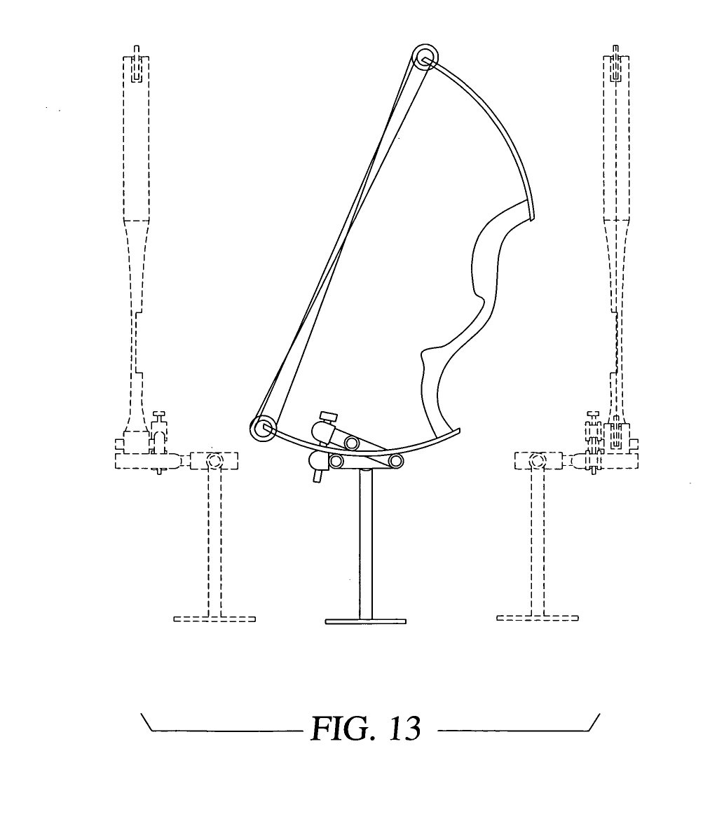

Referring to FIGS. 11-13, the versatility of the bow vise 10 of the present invention is apparent. FIG. 11 illustrates an archery bow clamped within swivel vise assembly 22 in an upright vertical position at its lower limb. Shown in phantom is the same archery bow rotated about 45° clockwise and 45° counter-clockwise from its vertical position. It will be appreciated that the bow could be rotated about axial axis A any desired amount up to 360°. FIG. 12 again illustrates an archery bow clamped within swivel vise assembly 22 in an upright vertical position at its lower limb, but also shows, in phantom, the bow rotated 90° clockwise and 90° counter-clockwise about transverse axis T. FIG. 13 illustrates the same archery bow clamped within swivel vise assembly 22 in an upright vertical position at its lower limb, but also shows, in phantom, the bow rotated 90° clockwise and 90° counter-clockwise about vertical axis V. The rotational positions shown in FIGS. 11-13 are merely illustrative, it being understood that the archery bow can be repositioned about more than one axis at a time and thereby achieve virtually any orientation which is desirable for tuning, adjusting or repairing the bow.

While the present invention has been described in terms of specific embodiments thereof, it will be understood that no limitations are intended to the details of construction or design other than as defined in the appended claims.

1. A bow vise for clamping an archery bow between first and second bow clamping means, comprising
first and second relatively pivotable bow clamping means movable about a common pivot axis between an open position and a bow clamping position and means for causing said bow clamping means to pivot about said pivot axis relative to each other
said means for causing pivoting comprising first and second rod supporting means on each of said first and second clamping means spaced from said pivot axis, each said rod supporting means including an aperture therethrough and being rotatable about an axis which is generally parallel to said pivot axis, one of said apertures being threaded and the other having a smooth bore, a threaded rod passing through both of said apertures and threadably engaged in said threaded aperture, biasing means extending between said first and second clamping means for biasing said first and second clamping means away from each other and knob means positioned on the end of said threaded rod remote from said threaded aperture for moving said threaded rod in clockwise and counter-clockwise directions,
whereby operating said knob means in one direction causes said threaded rod to thread through said threaded aperture, said knob means applying force to one of said rod supporting means against the biasing force of said biasing means to cause said first and second clamping means to move toward each other into said bow clamping position and operating said knob means in the opposite direction causes said first and second clamping means to move away from each other into said open position.

2. A bow vise, as claimed in claim 1, wherein said biasing means is a coiled spring.

3. A bow vise, as claimed in claim 1, wherein said biasing means surrounds said rod.

4. A bow vise, as claimed in claim 1, wherein said biasing means is a coiled spring having its end seated on said rod supporting means.

5. A bow vise, as claimed in claim 1, wherein each of said rod supporting means includes bracket means supporting an aperture-containing means which is rotatable in said bracket means about an axis which is generally parallel to said pivot axis.

6. A bow vise, as claimed in claim 5, wherein said aperture-containing means comprises a generally cylindrical pin means.

7. A bow vise, as claimed in claim 6, wherein said bracket means comprises a pair of generally parallel ears, each ear having an aperture therein, said pin means extending through and rotatable in said ear apertures.

8. A bow vise, as claimed in claim 1, wherein said rod supporting means are supported by a portion of said first and second clamping means remote from said pivot axis and project away from said pivot axis.

9. A bow vise, as claimed in claim 1, including means for rotating said archery bow about three mutually perpendicular axes for providing easy access to all portions of the archery bow from a single stationary location.

10. In a bow vise for securely clamping an archery bow comprising first and second relatively pivotable bow clamping means movable about a common pivot axis between an open position and a bow clamping position and means for pivoting said clamping means relative to each other about said pivot axis, said first clamping means comprising a generally U-shaped bracket having two generally parallel legs and said second clamping means comprising a tubular leg surrounding one of said parallel legs of said U-shaped bracket for defining with said one parallel leg said pivot axis,
the improvement comprising said second clamping means comprising a generally F-shaped bracket having a base leg and parallel upper and lower legs, the upper leg of said F-shaped bracket being said tubular leg and the lower leg of said F-shaped bracket extending parallel to the legs of said U-shaped first clamping means and being positioned intermediate the legs of said U-shaped first clamping means when said bow vise is in the clamping position for providing three point clamping contact on said archery bow.

11. A bow vise, as claimed in claim 10, wherein the improvement further comprises said means for pivoting comprises first and second rod supporting means on each of said first and second clamping means spaced from said pivot axis, each said rod supporting means including an aperture therethrough and being rotatable about an axis which is generally parallel to said pivot axis, one of said apertures being threaded and the other having a smooth bore, a threaded rod passing through both of said apertures and threadably engaged in said threaded aperture, biasing means extending between said first and second clamping means for biasing said first and second clamping means away from each other and knob means positioned on the end of said threaded rod remote from said threaded aperture for moving said threaded rod in clockwise and counter-clockwise directions,
whereby operating said knob means in one direction causes said threaded rod to thread through said threaded aperture, said knob means applying force to one of said rod supporting means against the biasing force of said biasing means to cause said first and second clamping means to move toward each other into said bow clamping position and operating said knob means in the opposite direction causes said first and second clamping means to move away from each other into said open position.

12. A bow vise, as claimed in claim 11, wherein said biasing means is a coiled spring.

13. A bow vise, as claimed in claim 11, wherein said biasing means surrounds said rod.

14. A bow vise, as claimed in claim 11, wherein said biasing means is a coiled spring having its end seated on said rod supporting means.

15. A bow vise, as claimed in claim 11, wherein each of said rod supporting means includes bracket means supporting an aperture-containing means which is rotatable in said bracket means about an axis which is generally parallel to said pivot axis.

16. A bow vise, as claimed in claim 15, wherein said aperture-containing means comprises a generally cylindrical pin means.

17. A bow vise, as claimed in claim 16, wherein said bracket means comprises a pair of generally parallel ears, each ear having an aperture therein, said pin means extending through and rotatable in said ear apertures.

18. A bow vise, as claimed in claim 11, wherein said rod supporting means are supported by a portion of said first and second clamping means remote from said pivot axis and project away from said pivot axis.

19. A bow vise, as claimed in claim 11, including means for rotating said archery bow about three mutually perpendicular axes for providing easy access to all portions of the archery bow from a single stationary location.

20. In a bow vise for securely clamping an archery bow comprising bow clamping means movable between an open position and a clamping position and means for rotating said archery bow about at least one axis, said means for rotating including first elongate means extending in a first direction from said clamping means and first elongate sleeve means receiving said first elongate means through one end thereof, said first elongate means extending through said first sleeve to the opposite end portion thereof, for rotation therewithin, said first elongate means having a first longitudinally extending axis, and rotation control means in releasable engagement with said first elongate means for allowing said first elongate means to be rotated clockwise or counter-clockwise about its axis or to be fixedly held in place against rotation, said clockwise and/or counter-clockwise movement of said first elongate means causing said clamping means to correspondingly rotate in a plane perpendicular to said first longitudinal axis,
the improvement comprising microadjustable means for allowing micro-rotational adjustments of the position of said archery bow, said microadjustable means comprising:
a microadjustment sleeve concentrically mounted over the other end of said first sleeve means;
said microadjustment sleeve engaging said first elongate means when said rotation control means fixedly holds said first elongate means in place against rotation;
first elongate base means attached to the outer surface of said microadjustment sleeve and oriented generally perpendicular to its axis, said base means having end portions extending beyond each side of said microadjustment sleeve;
means for applying an adjustable, controlled force to one of said end portions in a direction generally perpendicular to the longitudinal extent of said elongate base means and to the axis of said microadjustment sleeve;
whereby, with said rotation control means fixedly holding said first elongate means in place against rotation, said force causes said microadjustment sleeve to rotate, thereby causing the engaged first elongate means to likewise rotate which, in turn causes said clamping means to correspondingly rotate in a plane perpendicular to said axis.

21. A bow vise, as claimed in claim 20, further including second elongate base means supported opposite said first elongate base means on the other side of said microadjustment sleeve and out of contact with said microadjustment sleeve, said second elongate base means having end portions extending beyond each side of the microadjustment sleeve and being oriented parallel to and in registry with said first elongate base means, said second elongate base means including a threaded aperture in each of its end portions, threaded rod means extending through said threaded apertures into contact with the corresponding end portions of said first elongate base member, whereby each of said threaded rods can exert an adjustable, controlled force to one of the end portions of said first elongate base member as it is threaded through said threaded apertures.

22. A bow vise, as claimed in claim 20, including means for rotating said archery bow about two mutually perpendicular axes, said means further including second elongate means extending in a direction perpendicular to said first direction and second elongate sleeve means receiving said first elongate means through one end thereof, said second elongate means extending through said second sleeve to the opposite end portion thereof, for rotation therewithin, said second elongate means having a second longitudinally extending axis, and rotation control means in releasable engagement with said second elongate means for allowing said second elongate means to be rotated clockwise or counter-clockwise about its axis or to be fixedly held in place against rotation, said clockwise and/or counter-clockwise movement of said second elongate means causing said clamping means to correspondingly rotate in a plane perpendicular to said second longitudinal axis, and second microadjustable means mounted on said second sleeve, the microadjustment sleeve of said second microadjustable means being attached to said second elongate means when said rotation control means fixedly holds said second elongate means in place against rotation.
